(19) United States
(12) Patent Application Publication
(10) Pub. No.: US 2022/0348165 A1
(43) Pub. Date: Nov. 3, 2022

(54) CONTACTLESS ALARMING SYSTEM FOR PROACTIVE INTRUSION DETECTION

(71) Applicant: GM Global Technology Operations LLC, Detroit, MI (US)

(72) Inventors: Alaa M. Khamis, Courtice (CA); Arief Barkah Koesdwiady, Oshawa (CA); Kiana Karimpoor, Vaughan (CA); Mohannad Murad, Troy, MI (US)

(21) Appl. No.: 17/242,814

(22) Filed: Apr. 28, 2021

(51) Int. Cl. B60R 25/30; B60R 25/31; B60R 25/102; B60R 25/10

(52) U.S. Cl. CPC B60R 25/305; B60R 25/31; B60R 25/102; B60R 25/1003

(57) ABSTRACT

An alarm system and method of protecting a property from intrusion is disclosed. The property can be a vehicle that includes the alarm system. The alarm system includes an exterior camera for obtaining an exterior camera image data, an interior camera for obtaining an interior camera image data, and a processor. The processor is configured to determine first threat indicator for a potential intruder from the exterior camera image data, determine a second threat indicator for the potential intruder from the interior camera image data, determine a fused threat estimate indicative of an intention of the potential intruder from the first threat indicator and the second threat indicator, determine a consolidated threat estimate from the fused threat estimate and a contextual information for the property, and provide an alarm to protect the property from intrusion based on the consolidated threat estimate.

### INTRODUCTION

The subject disclosure relates to an alarm system for a vehicle and, in particular, to a proactive alarm system for detecting a potential intrusion and intruder malicious intention for the vehicle before a potential intruder makes contact with the vehicle.

A vehicle owner wants to know that their vehicle and any contents of the vehicle are safe from theft by an intruder. An alarm that sounds only at the time at which the intruder breaks into the vehicle does not prevent the intrusion and only alerts authorities once the intrusion occurs. Accordingly, it is desirable to provide an alarm system that can anticipate an intrusion and sound an alarm to preempt the intrusion.

### SUMMARY

In one exemplary embodiment, a method of protecting a property from intrusion is disclosed. A first threat indicator for a potential intruder to the property is determined from an interior camera image data obtained from an interior camera of the property. A second threat indicator for the potential intruder is determined from an exterior camera image data obtained from an exterior camera of the property. A fused threat estimate indicative of an intention of the potential intruder is determined from the first threat indicator and the second threat indicator. A consolidated threat estimate is determined from the fused threat estimate and a contextual information for the property. An alarm is provided to protect the property from intrusion based on the consolidated threat estimate.

In addition to one or more of the features described herein, the method further includes at least one of enhancing a quality of the interior camera image data to determine the first threat indicator and enhancing the quality of the exterior camera image data to determine the second threat indicator. The method further includes providing the alarm to a user of the property and updating the contextual information based on a response of the user to the alarm. The method further includes determining at least one of the first threat indicator and the second threat indicator from a persistence time of the potential intruder. The method further includes determining the persistence time of the potential intruder by tracking a bounding box in a plurality of frames from at least the interior camera image data and the exterior camera image data. Tracking the bounding box further includes at least one of determining a direction of feet of the potential intruder in the exterior camera image data, determining a presence of a face of the potential intruder at a window in the interior camera image data, and determining an amount of time the potential intruder is around the property.

In another exemplary embodiment, an alarm system for a property is disclosed. The alarm system includes an exterior camera for obtaining an exterior camera image data, an interior camera for obtaining an interior camera image data, and a processor. The processor is configured to determine first threat indicator for a potential intruder from the exterior camera image data, determine a second threat indicator for the potential intruder from the interior camera image data, determine a fused threat estimate indicative of an intention of the potential intruder from the first threat indicator and the second threat indicator, determine a consolidated threat estimate from the fused threat estimate and a contextual information for the property, and provide an alarm to protect the property from intrusion based on the consolidated threat estimate.

In addition to one or more of the features described herein, the processor is further configured to perform at least one of enhancing a quality of the exterior camera image data to determine the first threat indicator and enhancing the quality of the interior camera image data to determine the second threat indicator. The processor is further configured to provide the alarm to a user of the property. The processor is further configured to update a context database based on a response of the user to the alarm. The processor is further configured to determine at least one of the first threat indicator and the second threat indicator from a persistence time of the potential intruder. The processor is further configured to determine the persistence time of the potential intruder by tracking a bounding box in a plurality of frames from at least the exterior camera image data and the interior camera image data. The processor is further configured to determine, via tracking the bounding box, at least one of a direction of feet of the potential intruder in the exterior camera image data, a presence of a face of the potential intruder at a window in the interior camera image data, and an amount of time the potential intruder is around the property. In various embodiments, the property is one of a vehicle, a home, an office, a building, and a place of residence.

In another exemplary embodiment, a vehicle is disclosed. The vehicle includes an exterior camera for obtaining an exterior camera image data, an interior camera for obtaining an interior camera image data, and a processor. The processor is configured to determine first threat indicator for a potential intruder from the exterior camera image data, determine a second threat indicator for the potential intruder from the interior camera image data, determine a fused threat estimate indicative of an intention of the potential intruder from the first threat indicator and the second threat indicator, determine a consolidated threat estimate from the fused threat estimate and a contextual information for the vehicle, and provide an alarm to protect the vehicle from intrusion based on the consolidated threat estimate.

In addition to one or more of the features described herein, the processor is further configured to perform at least one of enhancing a quality of the exterior camera image data to determine the first threat indicator and enhancing the quality of the interior camera image data to determine the second threat indicator. The processor is further configured to provide the alarm to a user of the vehicle. The processor is further configured to update a context database based on a response of the user to the alarm. The processor is further configured to determine a persistence time of the potential intruder by tracking a bounding box in a plurality of frames from at least the exterior camera image data and the interior camera image data. The processor is further configured to determine, via tracking the bounding box, at least one of a direction of feet of the potential intruder in the exterior camera image data, a presence of a face of the potential intruder at a window in the interior camera image data, and an amount of time the potential intruder is around the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an alarm system for protecting a vehicle from a potential intruder;

FIG. 2 shows a flow chart of a computer-implemented method for determining a potential intrusion at the vehicle;

FIG. 3 shows a flow chart of a computer-implemented method of providing images of high image quality for use in assessing a threat level;

FIG. 4 shows a flowchart of a process for determining at least one of the first threat indicator and the second threat indicator from image data having a plurality of images;

FIG. 5 shows an illustrative side view image of an image obtained from an exterior camera of the vehicle;

FIG. 6 shows an illustrative interior camera image of an image obtained from an interior camera of the vehicle;

FIG. 7 shows a flowchart for determining a first threat indicator for the potential intruder;

FIG. 8 shows a flowchart for determining a second threat indicator for the potential intruder; and

FIG. 9 shows a flowchart for determining a persistence of a potential intruder within image data.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The system and methods disclosed herein are discussed specifically with reference to protection of a vehicle from an intrusion. This is not however meant to be a limitation of the invention. In other aspects. the alarm system disclosed herein can be used to protect any suitable occupiable property from intrusion, including the protection of a home, an office, a building, a place of residence, etc.

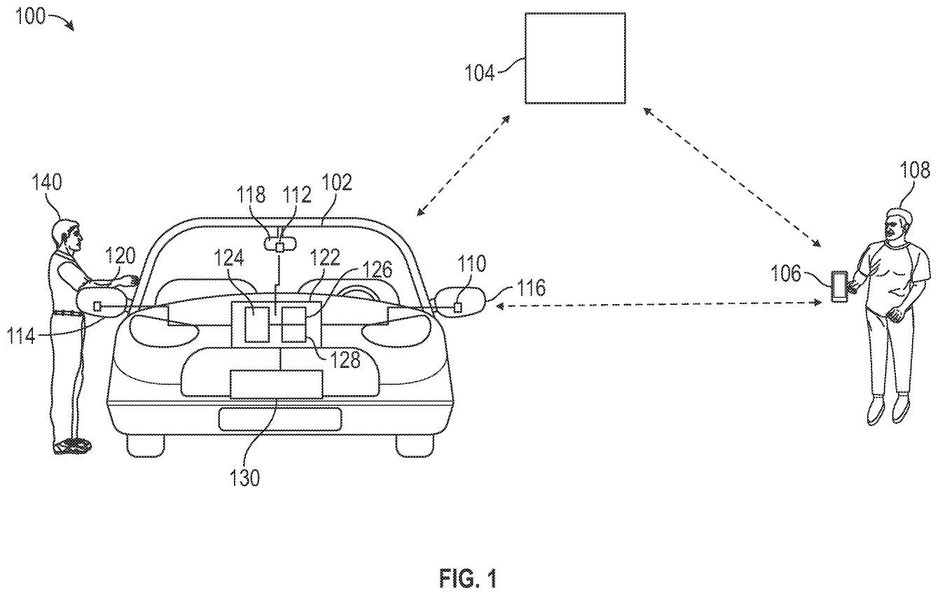

In accordance with an exemplary embodiment, FIG. 1 shows an alarm system 100 for protecting a vehicle 102 from a potential intruder 140. The alarm system 100 includes the vehicle 102, an alarm monitoring center 104 and a user notification device 106 which is in the possession of a user 108. The alarm monitoring center 104 can be a server or computer or an office having an operator that responds to alarms from the vehicle or any other suitable alarm center. The alarm monitoring center 104 can respond to a threat assessment, an alert or an alarm by notifying law enforcement of a potential or imminent intrusion into the vehicle 102. The user 108 can be an owner of the vehicle 102 or other person to whom the vehicle may be put in temporary custody or to whom the vehicle may be leased or rented. The user notification device 106 can be a suitable electronic device that allows two-way wireless communication between the vehicle 102 and the user 108. The user notification device 106 can be a dedicated electronic device or can be a smartphone operating an application or “app” that receives information from the vehicle 102, displays the information to the user 108, receives a response or input from the user and communicates the response or input back to the vehicle and/or to the alarm monitoring center 104.

The vehicle 102 includes a plurality of cameras placed at various locations on the vehicle. In the illustrative embodiment, the vehicle 102 includes an exterior camera (such as driver's side camera 110 and passenger's side camera 114) and an interior camera 112. The driver's side camera 110 is on the driver's side view mirror 116 and gives a view along the driver's side of the vehicle 102. The passenger's side camera 114 is located on the passenger's side view mirror 120 and gives a view along the passenger's side of the vehicle 102. The interior camera 112 is located in the cabin of the vehicle 102 and is generally located on the rear-view mirror 118. The interior camera 112 has a wide field of view and gives a view of the driver's seat, the driver's side window and other front and rear passenger windows. The driver's side camera 110, interior camera 112 and passenger's side camera 114 are in communication with a control unit 122 located at the vehicle and provide images and data to the control unit. The control unit 122 includes a processor 124 and a memory storage device 126 for storing various programs and databases 128 that, when accessed by the processor 124, enable the control unit 122 to assess a threat level indicating a potential intrusion into the vehicle or an intention of a potential intruder and sends out suitable communications in response to the threat level via a communication device 130 located at the vehicle 102. The memory storage device 126 can also store a record of the alarm and its veracity for use in the generation of future alarms. The communication device 130 communicates data or the threat assessment to at least one of the alarm monitoring center 104 and the user notification device 106.

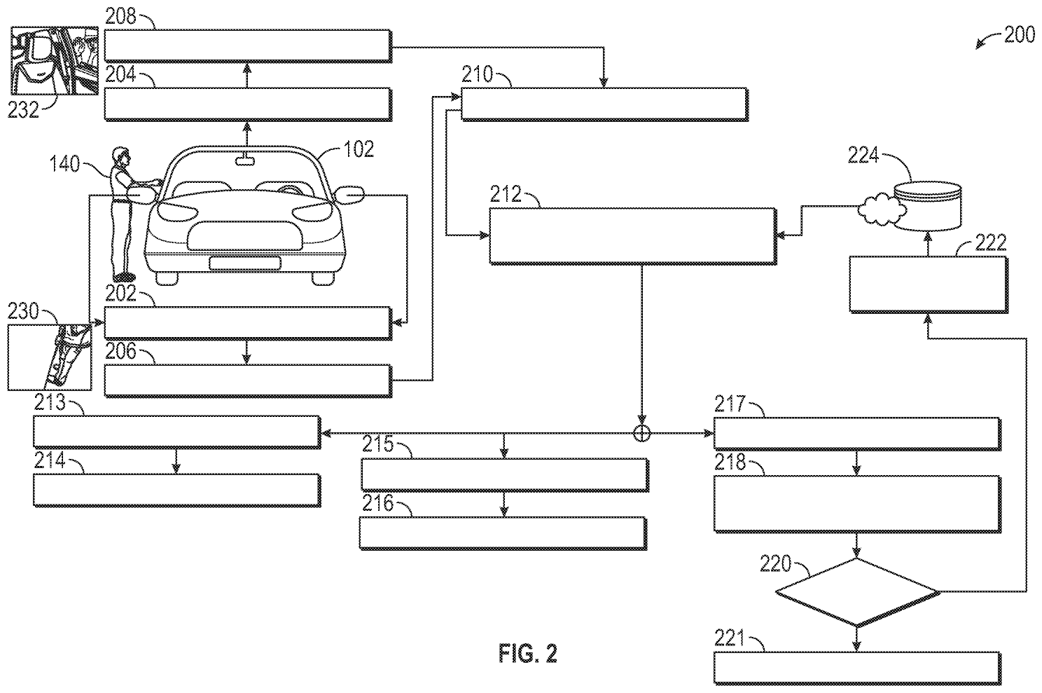

FIG. 2 shows a flow chart 200 of an illustrative computer-implemented method for determining a potential intrusion at the vehicle. In box 202, exterior camera image data is obtained from at least one of the side cameras (i.e., at least one of the driver's side camera 110 and the passenger's side camera 114). The exterior camera image data can be camera data such as a single side view image 230 or a movie or series of images temporally spaced apart from each other. In box 204, interior camera image data is obtained from the interior camera 112. The interior camera image data can also be a single cabin image 232 or a movie or series of images temporally spaced apart from each other. In various embodiments, an image from the exterior camera is obtained at the same time as an image from the interior camera.

In box 206, a first threat indicator (also referred to herein as an exterior camera-based threat indicator (ETI)) is determined based on information in the exterior camera image data. In box 208, a second threat indicator (also referred to herein as an interior camera-based threat indicator (ITI)) is determined based on information in the interior camera image data. In box 210, the first threat indicator ETI and the second treat indicator ITI are fused to obtain a fused threat estimate (FTE). In box 212, the fused threat estimate (FTE) is combined with contextual information to determine a consolidated threat estimate (CTE). The contextual information is provided from a context database 224, which can be stored in the memory storage device 126. The contextual information can be data about the threat levels associated with a particular time of day or location at which the image data are obtained. For example, a potential intruder 140 spotted in an image taken at 3:00 a.m. may imply a higher threat of intrusion than one spotted in an image taken at noon time. Also, a potential intruder 140 spotted in an image taken when the vehicle 102 is in a location having high crime rate may imply a higher threat of intrusion than one spotted in an image taken when the vehicle is in a location having a low crime rate. The fused threat estimate and the contextual information are used to determine the consolidated threat estimate.

In various embodiments, the consolidated threat estimate can be one of three states: “No Threat”, “Low Threat” and “High Threat”. When the consolidated threat estimate yields “No Threat” (box 213), then the method proceeds to box 214 at which nothing is done. When the consolidated threat estimate yields “Low Threat” (box 215) then the method proceeds to box 216. At box 216, the vehicle provides a local warning to the potential intruder, such as by flashing a light or a sounding an alarm or horn. The local warning can be a gentle warning to the potential intruder that can be received easily by the potential intruder.

When the consolidated threat estimate yields “High Threat” (box 217) then the method proceeds to box 218. At box 218, data can be communicated to the user notification device 106 in order to get input from the user regarding the need for alerting the alarm monitoring center 104. The data communicated to the user notification device 106 can include a snapshot or image from at least one of the exterior camera image data and the interior camera image data, such as an image of a face of the potential intruder, thereby allowing the user to identify the potential intruder and to assess the potential of intrusion. The data communicated to the user notification device 106 can also indicate the threat level posed by the potential intruder.

At box 220, the control unit 122 receives the user response and selects a course of action. If the user 108 acknowledges that the alarm monitoring center 104 should be notified of the potential intruder, then in box 221 the vehicle 102 notifies the alarm monitoring center 104 to notify law enforcement. The vehicle 102 can also notify the user that an alarm was sent to the alarm monitoring center 104. Returning to box 220, if the user 108 indicates that the potential intruder is not to be considered an intruder, then at box 222 the contextual information in the context database 224 is updated to reflect the response from the user 108. By using the context database 224 as well as by notifying the user of a threat and asking for a response from the user, the vehicle 102 reports a low number of false alarms to the alarm monitoring center 104.

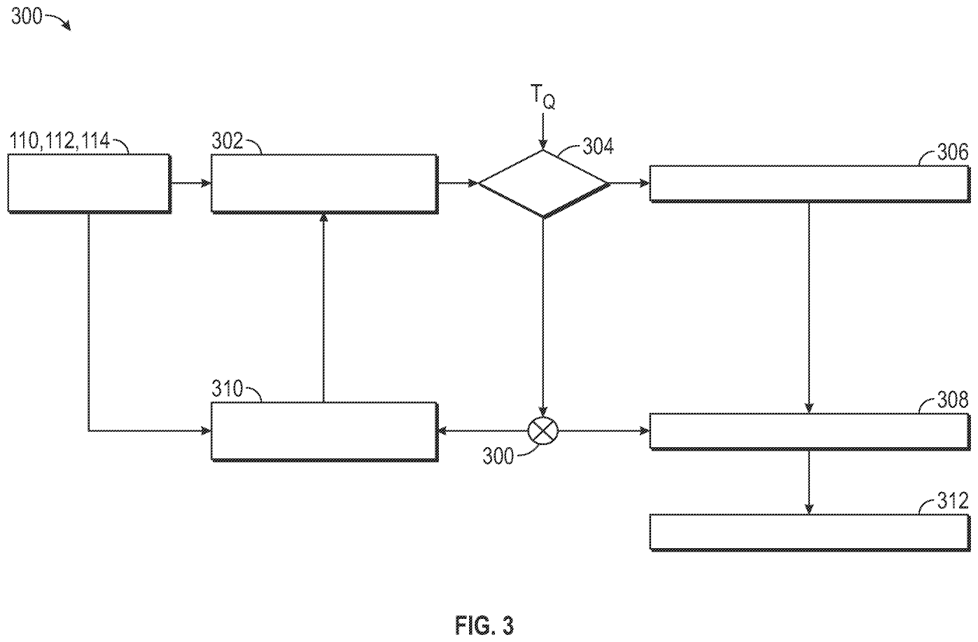

FIG. 3 shows a flow chart 300 of a computer-implemented method of providing images of high image quality for use in assessing a threat level. Assessing the threat level requires images of high quality in order to be able to identify the potential intruder. An image quality threshold T_{Q} is selected based on various image quality requirements of the alarm system. In box 302, image data (such as from driver's side camera 110, interior camera 112 and/or passenger's side camera 114) are reviewed and an image quality index (IQI) is assigned to the image. In box 304, the image quality index is compared to an image quality threshold (TQ). If the image quality index is greater than or equal to the image quality threshold (IQI>=T_{Q}), then the image is approved for threat level assessment and the method proceeds to box 306. In box 306, a first threat indicator and/or a second threat indicator is determined based on which camera obtained the approved image. In box 308, the first threat indicator and the second threat indicator are used to generate the fused threat estimate (box 312).

Returning to box 304, if the image quality index of the image is less than the image quality threshold (IQI<T_{Q}), then the method proceeds to box 310. In box 310, the image is enhanced using any suitable form of image processing, such as filtering, noise reduction, etc. The enhanced image is then reviewed at box 302 to determine an image quality index for the enhanced image and the image quality index is compared to the image quality threshold at box 304. The enhanced image can be returned to the image enhancer any number of times until the image quality is approved (i.e., until IQI>=T_{Q}).

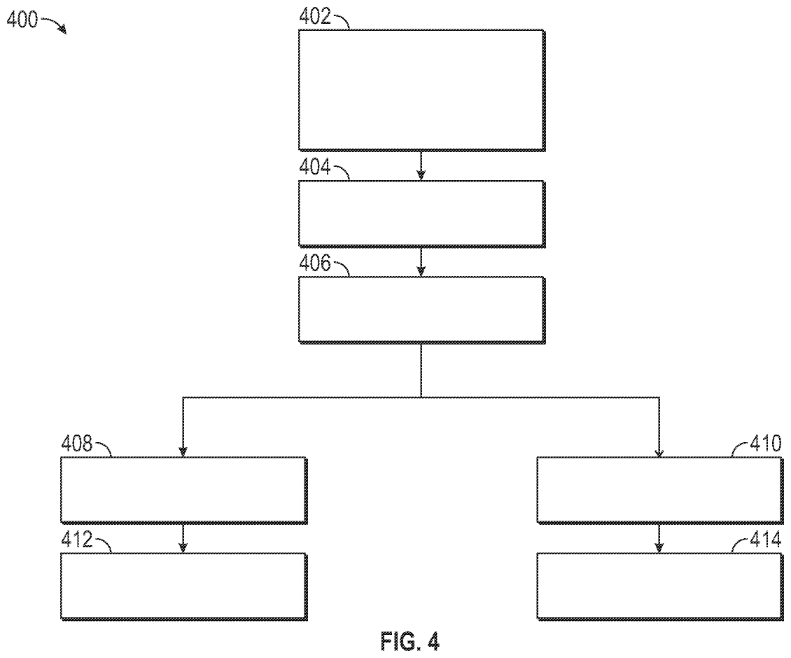

FIG. 4 shows a flowchart 400 of a process for determining at least one of the first threat indicator and the second threat indicator from image data having a plurality of images. In box 402, the image data is received and includes a set of k frames (or k single images) taken in sequence and separated temporally, such as, for example, by about 1/10 of a second between frames.

At box 404, the potential intruder is detected in the image using an object detection algorithm. In the object detection algorithm, a bounding box is drawn around the potential intruder. The bounding box is used to track the potential intruder through the subsequent images of the k frames. In box 406, the bounding boxes are used to track a motion of the potential intruder. Tracking the potential intruder includes use of a Linear Kalman Filter and of a Data Association algorithm. The Linear Kalman filter is applied to a bounding box within a frame to estimate a motion of the bounding box and the estimated location of the bounding box at the next frame. The estimated location of the bounding box in the subsequent frame is then associated to the observed bounding box of the next frame using suitable association methods, such as a Hungarian method of data association. The associated bounding boxes through the k frames form a track.

The tracks are sent to either box 408 or box 410 based on the camera from which the image data was obtained. In box 408, face detection is performed on the track. Face detection is performed on image data obtained from the interior camera 112. A face detection module locates a human face within the bounding boxes. While discussed with respect to face detection, the detection step can be applied to any human body part that is within the field of view of the interior camera, including face, hands, head, upper torso, etc. In box 412, feet pose estimation is performed on the track. Feet pose estimation determines a direction in which the feet are facing (feet pose 414) with respect to the vehicle. Feet pose estimation is performed when the sequence of images are from one of the driver's side camera and the passenger's side camera.

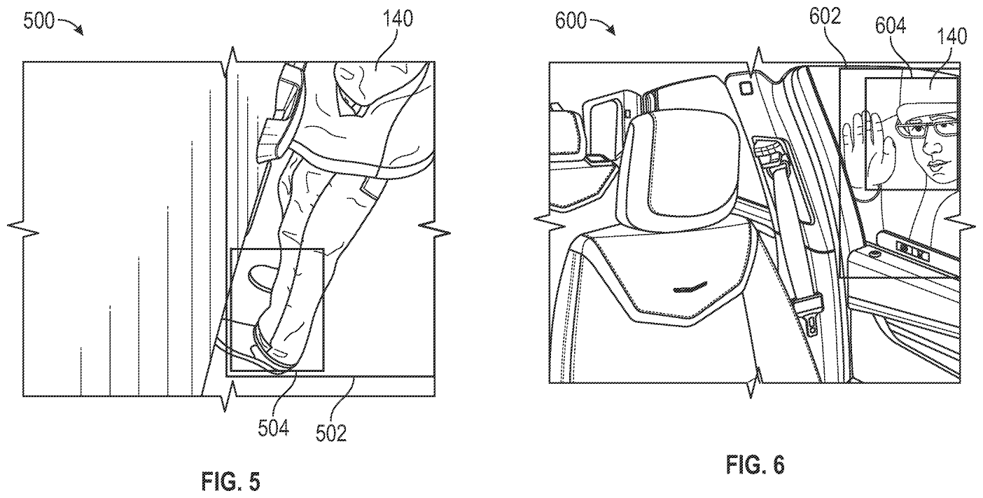

FIG. 5 shows an illustrative side view image 500 obtained from the driver's side camera 110 of the vehicle 102. The illustrative side view image 500 includes a bounding box 502 that surrounds the visible portion of the potential intruder proximate the vehicle 102. A feature box 504 surrounds the feet of the potential intruder.

FIG. 6 shows an illustrative interior camera image 600 obtained from the interior camera 112 of the vehicle 102. The illustrative interior camera image 600 includes a bounding box 602 that surrounds the visible portion of the potential intruder 140, who is peering inside the cabin of the vehicle 102. A feature box 604 surrounds the face of the potential intruder.

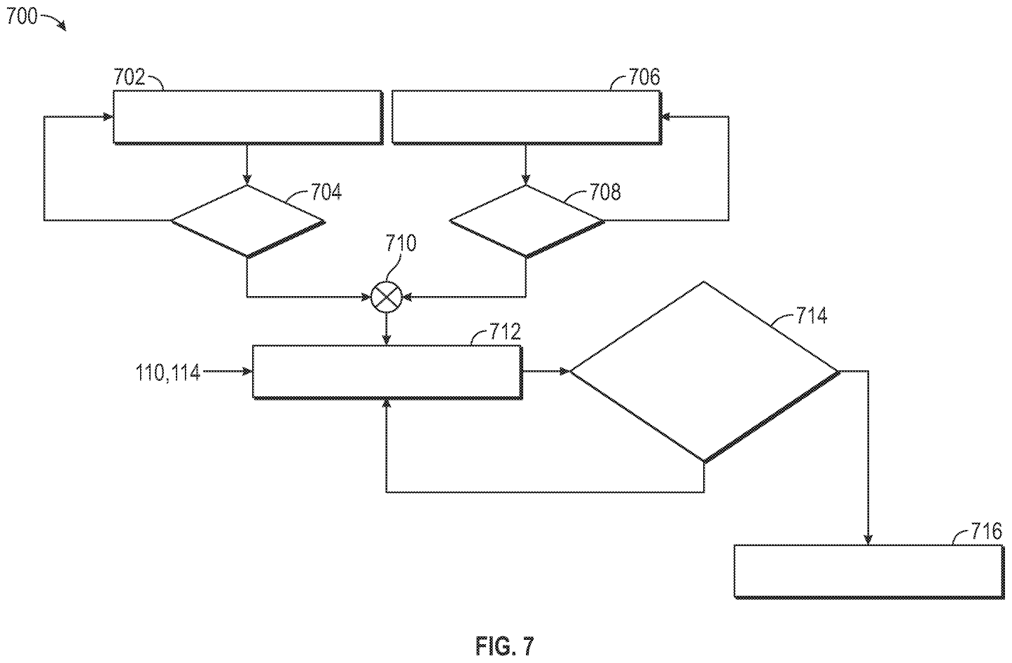

FIG. 7 shows a flowchart 700 for determining a first threat indicator for the potential intruder. In box 702, a status of the vehicle is obtained or measured. The status of the vehicle indicates whether the vehicle is locked or unlocked. At box 704, if the vehicle is unlocked, the method returns to box 702. If, at box 704, the vehicle is locked, then this information is provided to a logic gate 710. Simultaneously with checking the vehicle state, in box 706, the status of a key fob for the vehicle or a smart phone of an authorized driver/passenger is also obtained or measured. At box 708, if the key fob is close to the vehicle, the method returns to box 706. If, at box 708, the key fob is determined to be away from the vehicle, then this information is provided to logic gate 710. At logic gate 710, when both the vehicle is locked and the key fob is away from the vehicle, the method proceeds to monitor the environment of the images being obtained.

In box 712, an object detection and tracking program generates bounding boxes from the camera image data from the exterior cameras 110, 114. At box 714, it is determined whether the potential intruder has feet point toward the vehicle or away. If the potential intruder does not have feet pointed toward the vehicle, the method returns to box 712. If the feet of the potential intruder are facing toward the vehicle, the method proceeds to box 716 to generate a first threat indicator. The first threat indicator can be provided to a fusion module to generate a fused threat estimate.

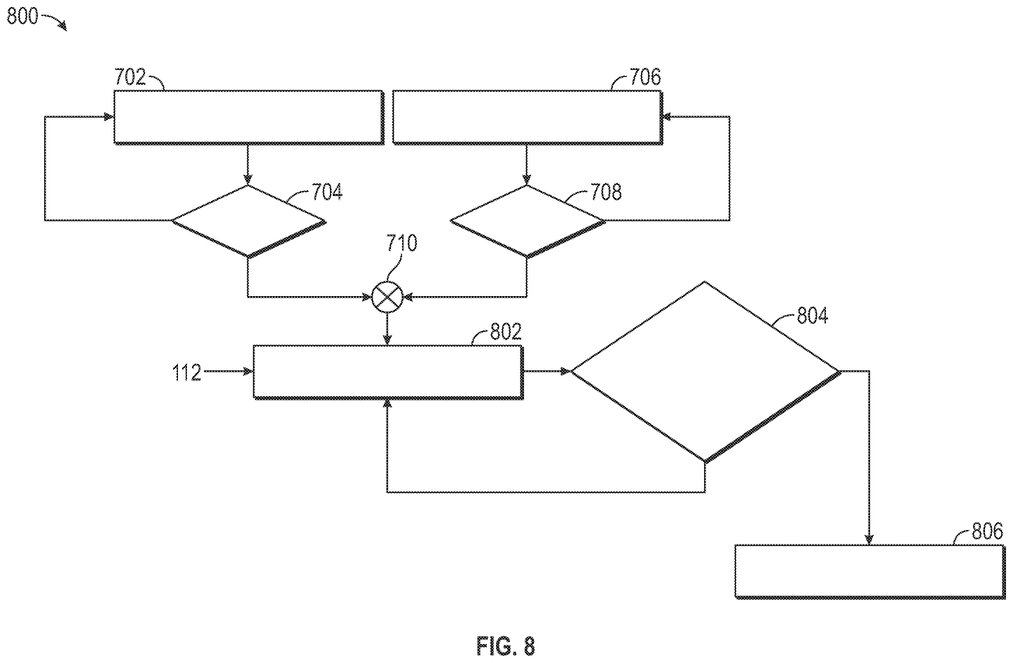

FIG. 8 shows a flowchart 800 for determining a second threat indicator for the potential intruder. The flowchart 800 includes box 702, box 704, box 706, box 708 and the logic gate 710 for determining when to monitor the environment. In box 802, the object detection and tracking program generates bounding boxes with interior camera data from the interior camera 112. At box 804, it is determined whether a face of the potential intruder is peering into the vehicle. If the potential intruder is not peering into the vehicle, the method returns to the object detection and tracking program being performed in box 802. If the potential intruder is peering into the vehicle, the method proceeds to box 806 to generate a second threat indicator. The second threat indicator can be provided to a fusion module to generate a fused threat estimate.

In various embodiments, the threat level generated is based on a persistence of the potential intruder within the k frames. The persistence of the potential intruder is determined by measuring an amount of time that the potential intruder is seen on camera. An innocent person generally does not linger around a vehicle due to a general lack of interest in breaking into the vehicle, while a malicious person tends to spend time looking inside the vehicle to assess the possible risks and rewards of breaking in. The malicious person can be detected by tracking his persistence within the frames.

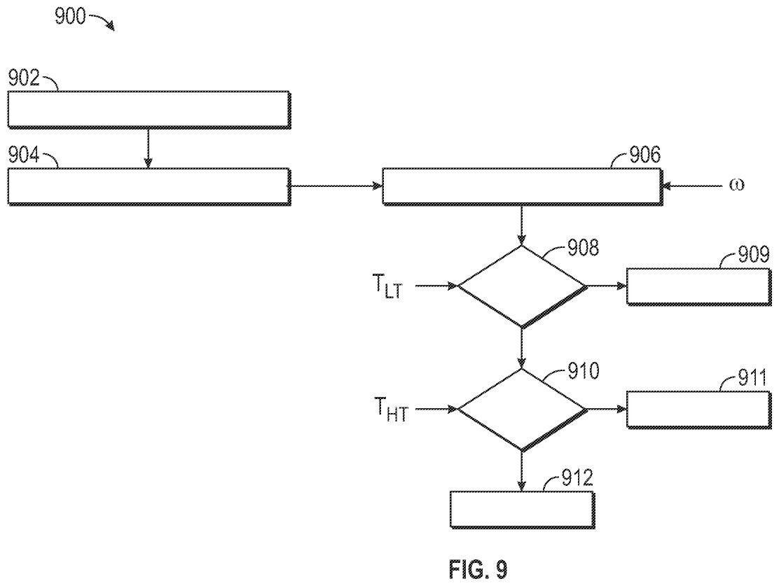

FIG. 9 shows a flowchart 900 of a method for determining a persistence of a potential intruder within image data. In box 902, image data is received that includes a set of k frames (or k single images) taken sequentially and bounding boxes are determined for the set of frames of image data. In box 904, a set of tracks ρ={ρ₁,ρ₂, . . . , ρₙ} is generated from the bounding boxes, wherein the index n is the number of tracks. Each track is a video or image sequence in which the potential intruder is spotted in the image data. There can be a plurality of tracks as the potential intruder can move in and out of the field of view of a given camera. In box 906, for each track, a length of time is determined in which the potential intruder appears in the tracks within a time window ω. The length of time for the plurality of tracks gives a set of persistence times t={t₁, t₂, . . . , tₙ}. The time window ω can be a calibrated time window. A maximum persistence time is determined from the persistence times, where the maximum persistence time is tₘₐₓ=max{t₁, t₂, . . . , tₙ}.

At box 908, the maximum persistence time tₘₐₓ is compared to a low threat threshold T_{LT}. The low threat threshold T_{LT} can be calibrated based on a priori knowledge and contextual information, where the contextual information can be updated based on a history of previous alarms. If the maximum persistence time is less than the low threat threshold (i.e., tₘₐₓ<T_{LT}), the relevant threat indicator is stated as “No Threat” (box 909). If, however, the maximum persistence time is greater than or equal to the low threat threshold (i.e., tₘₐₓ>=T_{LT}), the method proceeds to box 910. At box 910, if the maximum persistence time is less than a high threat threshold (i.e., tₘₐₓ<T_{HT}), the threat indicator is stated as “Low Threat” (box 911). If, however, the maximum persistence time is greater than or equal to the high threat threshold (i.e., tₘₐₓ>=T_{HT}), the threat indicator is stated as “High Threat” (box 912).

Due to the use of cameras and image data, the alarm system is a contactless alarm system, since the potential intruder and/or an intention of the potential intruder can be identified and an alarm can be sounded without the potential intruder making physical contact with the vehicle. The alarm system therefore can anticipate the intentions of the potential intruder and alert the user and/or sound the alarm based on these intentions.

Table 1 is an illustrative table for generating a fused threat estimate from threat indicators from the camera systems.

TABLE 1

| Exterior | Interior | |
|---|---|---|
| Camera-based | Camera-based | Fused Threat Estimate |
| Threat Indicator (ETI) | Threat Indicator (ITI) | (FTE) = max(ETI, ITI) |
| No Threat | No Threat | No Threat |
| Low Threat | No Threat | Low Threat |
| No Threat | Low Threat | Low Threat |
| Low Threat | Low Threat | Low Threat |
| High Threat | No Threat | High Threat |
| No Threat | High Threat | High Threat |
| Low Threat | High Threat | High Threat |
| High Threat | Low Threat | High Threat |
| High Threat | High Threat | High Threat |

The left column includes possible values for a first threat indicator (ETI) generated from images obtained from at least one of the exterior cameras (i.e., driver's side camera 110 and passenger's side camera 114). The middle column includes possible values for a second threat indicator (ITI) generated from images obtained from the interior camera 112. The right column includes values of a fused threat estimate (FTE) based on the first threat indicator (ETI) and the second threat indicator (ITI). In various embodiments, the fused threat estimate is a maximum value of the first threat indicator and the second threat indicator.

The ETI is generated if the IQI of the exterior camera (IQI_{SC}) is greater than an image quality threshold (i.e., if IQI_{SC}>=T_{Q}) even if the IQI the interior camera does not meet the image quality threshold (i.e., IQI_{IC}<T_{Q}). Similarly, the ITI is generated if the IQI of the interior camera (IQI_{IC}) is greater than an image quality threshold (i.e., if IQI_{IC}>=T_{Q}) even if the IQI of the exterior camera does not meet the image quality threshold (i.e., if IQI_{EC}<T_{Q}). However, the FTE can be generated only when both the IQI of the exterior camera and the IQI of the interior camera are both greater than the image quality threshold (i.e., when both IQI_{EC}>=T_{Q} and IQI_{IC}>=T_{Q}).

Table 2 is an illustrative table for generating a consolidated threat estimate (CTE) using the fused threat estimate (FTE) from Table 1 and contextual information.

TABLE 2

| | | | Consolidated |
|---|---|---|---|
| Fused Threat | Contextual Information | | Threat Estimate |
| Estimate (FTE) | Location | Time | (CTE) |
| No Threat | Any | Any | No Threat |
| Low Threat | Safe Area | Normal | Low Threat |
| Low Threat | Safe Zone | Too Early/Too Late | High Threat |
| Low Threat | Dangerous Zone | Normal | High Threat |
| Low Threat | Dangerous Zone | Too Early/Too Late | High Threat |
| High Threat | Safe Area | Normal | High Threat |
| High Threat | Safe Zone | Too Early/Too Late | High Threat |
| High Threat | Dangerous Zone | Normal | High Threat |
| High Threat | Dangerous Zone | Too Early/Too Late | High Threat |

The left column includes the possible levels of the fused threat estimate (“No Threat”, “Low Threat” and “High Threat”). The middle column includes a left middle column which includes a location context and a right middle column which includes a time context. The location context generally includes whether the area is considered safe (“Safe Area”) or dangerous (“Dangerous Zone”). The time context generally based on which time of the day is more likely that a car may be stolen. A “Normal” time indicates a time during which car theft is generally low and a “Too Early/Too Late” indicates a time during which car theft is generally high, such as 3:00 a.m., for example. The right column indicates the value of the consolidated threat estimate (CTE) generated based on the fused threat estimate, the location context and the time context.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of protecting a property from intrusion, comprising:
determining a first threat indicator for a potential intruder to the property from an interior camera image data obtained from an interior camera of the property;
determining a second threat indicator for the potential intruder from an exterior camera image data obtained from an exterior camera of the property;
determining a fused threat estimate indicative of an intention of the potential intruder from the first threat indicator and the second threat indicator;
determine a consolidated threat estimate from the fused threat estimate and a contextual information for the property; and
provide an alarm to protect the property from intrusion based on the consolidated threat estimate.

2. The method of claim 1, further comprising at least one of: (i) enhancing a quality of the interior camera image data to determine the first threat indicator; and (ii) enhancing the quality of the exterior camera image data to determine the second threat indicator.

3. The method of claim 1, further comprising providing the alarm to a user of the property and updating the contextual information based on a response of the user to the alarm.

4. The method of claim 1, further comprising determining at least one of the first threat indicator and the second threat indicator from a persistence time of the potential intruder.

5. The method of claim 4, further comprising determining the persistence time of the potential intruder by tracking a bounding box in a plurality of frames from at least the interior camera image data and the exterior camera image data.

6. The method of claim 5, wherein tracking the bounding box further comprises at least one of: (i) determining a direction of feet of the potential intruder in the exterior camera image data; (ii) determining a presence of a face of the potential intruder at a window in the interior camera image data; and (iii) determining an amount of time the potential intruder is around the property.

7. An alarm system for a property, comprising:
an exterior camera for obtaining an exterior camera image data;
an interior camera for obtaining an interior camera image data; and
a processor configured to:
determine first threat indicator for a potential intruder from the exterior camera image data;
determine a second threat indicator for the potential intruder from the interior camera image data;
determine a fused threat estimate indicative of an intention of the potential intruder from the first threat indicator and the second threat indicator;
determine a consolidated threat estimate from the fused threat estimate and a contextual information for the property; and
provide an alarm to protect the property from intrusion based on the consolidated threat estimate.

8. The alarm system of claim 7, wherein the processor is further configured to perform at least one of: (i) enhancing a quality of the exterior camera image data to determine the first threat indicator; and (ii) enhancing the quality of the interior camera image data to determine the second threat indicator.

9. The alarm system of claim 7, wherein the processor is further configured to provide the alarm to a user of the property.

10. The alarm system of claim 9, wherein the processor is further configured to update a context database based on a response of the user to the alarm.

11. The alarm system of claim 7, wherein the processor is further configured to determine at least one of the first threat indicator and the second threat indicator from a persistence time of the potential intruder.

12. The alarm system of claim 11, wherein the processor is further configured to determine the persistence time of the potential intruder by tracking a bounding box in a plurality of frames from at least the exterior camera image data and the interior camera image data.

13. The alarm system of claim 12, wherein the processor is further configured to determine, via tracking the bounding box, at least one of: (i) a direction of feet of the potential intruder in the exterior camera image data; (ii) a presence of a face of the potential intruder at a window in the interior camera image data; and (iii) an amount of time the potential intruder is around the property.

14. The alarm system of claim 7, wherein the property is one of: (i) a vehicle; (ii) a home; (iii) an office; (iii) a building; and (iv) a place of residence.

15. A vehicle, comprising:
an exterior camera for obtaining an exterior camera image data;
an interior camera for obtaining an interior camera image data; and
a processor configured to:
determine first threat indicator for a potential intruder from the exterior camera image data;
determine a second threat indicator for the potential intruder from the interior camera image data;
determine a fused threat estimate indicative of an intention of the potential intruder from the first threat indicator and the second threat indicator;
determine a consolidated threat estimate from the fused threat estimate and a contextual information for the vehicle; and
provide an alarm to protect the vehicle from intrusion based on the consolidated threat estimate.

16. The vehicle of claim 15, wherein the processor is further configured to perform at least one of: (i) enhancing a quality of the exterior camera image data to determine the first threat indicator; and (ii) enhancing the quality of the interior camera image data to determine the second threat indicator.

17. The vehicle of claim 15, wherein the processor is further configured to provide the alarm to a user of the vehicle.

18. The vehicle of claim 17, wherein the processor is further configured to update a context database based on a response of the user to the alarm.

19. The vehicle of claim 15, wherein the processor is further configured to determine a persistence time of the potential intruder by tracking a bounding box in a plurality of frames from at least the exterior camera image data and the interior camera image data.

20. The vehicle of claim 19, wherein the processor is further configured to determine, via tracking the bounding box, at least one of: (i) a direction of feet of the potential intruder in the exterior camera image data; (ii) a presence of a face of the potential intruder at a window in the interior camera image data; and (iii) an amount of time the potential intruder is around the vehicle.
